(19) United States
(12) Patent Application Publication
(10) Pub. No.: US 2005/0289101 A1
(43) Pub. Date: Dec. 29, 2005

(54) Methods and systems for dynamic partition management of shared-interconnect partitions

(76) Inventor: Doddaballapur Jayasimha, Sunnyvale, CA (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/877,633

(22) Filed: Jun. 25, 2004

(51) Int. Cl. G06F 7/00

(52) U.S. Cl. 707/1

(57) ABSTRACT

Methods and systems for dynamic partitioning of multiple processor systems. Upon receipt of an on-line event request, the routing management application dynamically implements an alternate routing table (ART) for all nodes affected by the on-line event, the ART reflecting an altered system topology corresponding to the on-line event. For one embodiment, nodes affected by the on-line event are determined and source nodes are quiesced. An ART is loaded for each determined node and the nodes are directed to use the ART. The quiesced source nodes are then directed to leave quiescence. An alternative embodiment of the invention is applicable to a multiple processor system supporting multiple virtual networks. An ART, specific to a virtual network not used for primary routing, is loaded for each determined node. The primary routing table is used concurrently with the ART until each source node has been directed, and has begun to use the ART.

### FIELD

Embodiments of the invention relate generally to the field of partitioned multiple-processor systems, and more specifically to methods for effecting the partitioning of such systems.

### BACKGROUND

Increasing data processing requirements have led to the development of larger and more complicated applications. Multiple-processor systems (MPSs) have been developed to execute such applications more quickly and efficiently.

A typical MPS may be implemented using a bus-based interconnection scheme. FIG. 1 illustrates a bus-based MPS in accordance with the prior art. System 100, shown in FIG. 1, includes processors 105a-105d. The processors are connected through a common (shared) bus 110 to chipset 115. The chipset is in turn connected to a memory 120. The bus-based interconnection scheme has distinct disadvantages in the areas of performance, scalability, and reliability. Performance for such a system suffers due to the length of the shared bus. That is, the length of the wire providing electrical connection between processors is dependent upon the number of processors in the MPS. A greater number of processors and the length of the electrical connection reduces the effective speed at which the processors can be operated. Bus-based systems are not scalable in that the shared bus acts as a bottleneck when more processors are added. Moreover, the fact that all of the processors share a common bus means that if the bus fails for any reason, all of the processors are inoperable, thus reliability is jeopardized by the bus-based design.

To address these disadvantages, MPSs having a point-to-point, link-based interconnection scheme have been developed. Each node of such a system includes an agent (e.g., processor, memory controller, I/O hub component, chipsets, etc.) and a router for communicating messages between connected nodes. Each node may be directly connected to only a subset of the other nodes of the system. Typically such systems have a single manager for the entire system, but allow partitioning of the resources into logically independent systems, so that, for example, for an eight-processor MPS, two processors may be used for a first application, two others may be used for a second application, and the remaining four may be used for a third application.

Such systems provide improved performance, scalability, and reliability, but at the expense of a more complicated interconnect management protocol. That is, because there are multiple processors acting independently, synchronization is more complicated than the bus-based scheme that has a single point of synchronization. While overcoming many of the disadvantages of a bus-based scheme, the link-based implementation presents its own drawbacks as illustrated by reference to FIG. 2 and FIG. 3.

FIG. 2 illustrates an MPS implemented using a point-to-point interconnection scheme in accordance with the prior art. MPS 200, shown in FIG. 2, includes agents 0-7, each of which may include, for example, an integrated processor, memory controller, and router. As shown in FIG. 2, agents 0-7 are interconnected using a point-to-point interconnection scheme. Agents 0-7 are partitioned into two partitions, namely partition 205, which includes agents 0, 2, 5, and 7, and partition 210, which includes agents 1, 3, 4, and 6. Such logical partitioning, though providing flexibility in regard to resource allocation, may also impede performance. For such partitioning, the addition or removal of a node from a partition requires not only that the subject partition (the partition having a node added or deleted) be reset or quiesced, but requires the rest of the system be quiesced as well. For example, a transaction communicated between agent 2 and agent 7 of partition 205 must route through an agent (e.g., agent 3) of partition 210. Therefore, should an agent in partition 210 fail, or otherwise be removed from the system, thus requiring partition 210 to be quiesced, partition 205 would also have to be quiesced as well.

For a system topology providing a high degree of flexibility (flexible route through), the addition or removal of a node from a partition requires the entire system to be quiesced. The time required to quiesce the entire system should optimally be as small as possible so as not to adversely affect system timeouts.

To avoid having to quiesce the entire MPS, the system topology may be constrained such that communications between agents of a given partition are not routed through agents of a different partition.

FIG. 2A illustrates an MPS implemented using a point-to-point interconnection scheme having a constrained topology in accordance with the prior art. As shown in FIG. 2, agents 0-7 are partitioned into two partitions, namely partition 205A, which includes agents 1, 3, 5, and 7, and partition 210A, which includes agents 0, 2, 4, and 6. Transactions communicated between agents of one partition need not be routed through agents of the other partition. Therefore, the addition or removal of a node from a partition requires quiescing of only the subject partition; the topology constraint ensures that there are no affected partitions requiring quiescing. Such constraints, however, limit the flexibility of the system and do not provide flexibility in repartitioning (partitioning) and resource allocation.

### BRIEF DESCRIPTION OF THE DRAWINGS

The invention may be best understood by referring to the following description and accompanying drawings that are used to illustrate embodiments of the invention. In the drawings:

FIG. 1 illustrates a bus-based MPS in accordance with the prior art;

FIG. 2 illustrates an MPS implemented using a point-to-point interconnection scheme in accordance with the prior art;

FIG. 2A illustrates an MPS implemented using a point-to-point interconnection scheme having a constrained topology in accordance with the prior art;

FIG. 3 illustrates a process in which an MPS is dynamically partitioned in accordance with one embodiment of the invention;

FIG. 4 illustrates a timeline of the operations described in reference to FIG. 3 in accordance with one embodiment of the invention;

FIG. 4A illustrates a timeline of a process for effecting dynamic partitioning of a MPS in accordance with one embodiment of the invention;

FIG. 5 illustrates a process in which an MPS is dynamically partitioned in accordance with one embodiment of the invention; and

FIG. 6 illustrates a timeline of the operations described in reference to FIG. 5 in accordance with one embodiment of the invention.

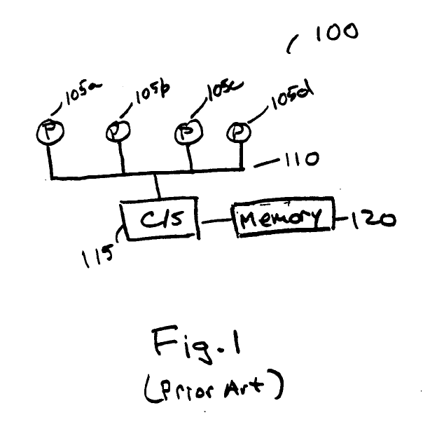

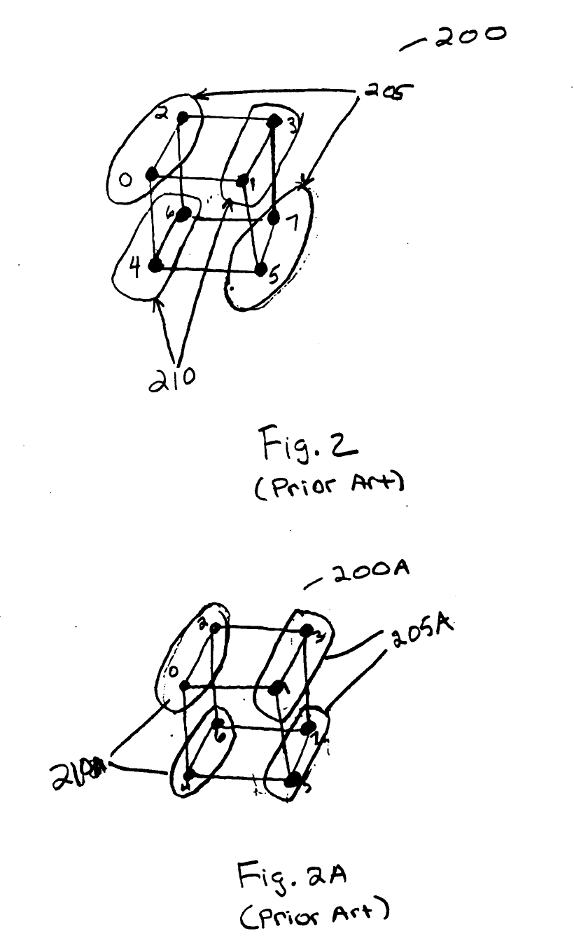

### DETAILED DESCRIPTION

In the following description, numerous specific details are set forth. However, it is understood that embodiments of the invention may be practiced without these specific details. In other instances, well-known circuits, structures and techniques have not been shown in detail in order not to obscure the understanding of this description.

Reference throughout the specification to “one embodiment” or “an embodiment” means that a particular feature, structure, or characteristic described in connection with the embodiment is included in at least one embodiment of the present invention. Thus, the appearance of the phrases “in one embodiment” or “in an embodiment” in various places throughout the specification are not necessarily all referring to the same embodiment. Furthermore, the particular features, structures, or characteristics may be combined in any suitable manner in one or more embodiments.

Moreover, inventive aspects lie in less than all features of a single disclosed embodiment. Thus, the claims following the Detailed, Description are hereby expressly incorporated into this Detailed Description, with each claim standing on its own as a separate embodiment of this invention.

Typically, the routing of messages (e.g., packets) in a MPS implemented using a point-to-point interconnection scheme is effected through the use of routing tables. In such networks messages proceed from a source node, through zero or more intermediate nodes, to a destination node. Each message contains an associated destination, and when a message is received at an intermediate node, the routing algorithm references the routing table to determine the next link over in which to route the message. In accordance with one embodiment of the invention, both a primary routing table (PRT) as well as an alternate routing table (ART) are created and programmed for each agent. The PRT is the routing table during normal operation of the MPS, while an ART is used upon the occurrence of a dynamic partitioning event or on-line event (OLE). An OLE is the addition or removal of a node from a partition. The occurrence of an OLE results in a change in the system topology. The topology of the system is altered by the OLE in that if a node is deleted, some routing paths no longer exist, since the node and its associated router are removed from the system. Likewise, the addition of a node results in the availability of additional routing paths. When this happens routing is switched from the PRT to the ART; the ART then becomes the PRT.

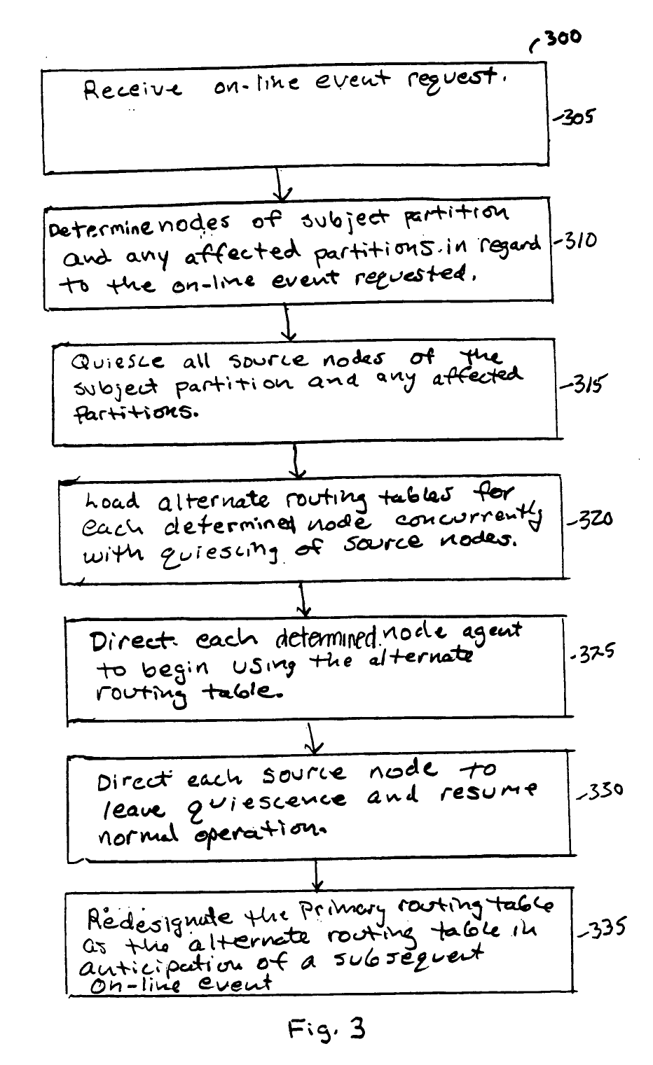

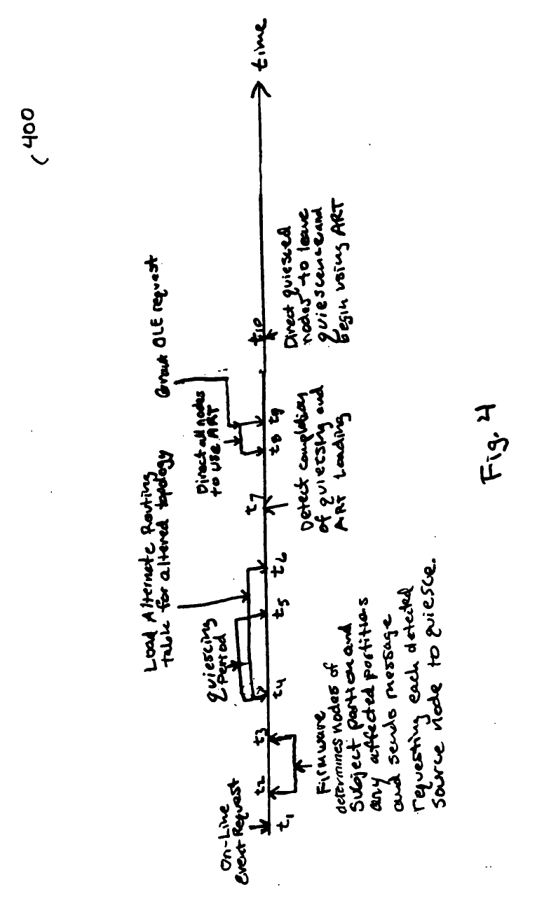

FIG. 3 illustrates a process in which a MPS is dynamically partitioned in accordance with one embodiment of the invention. Process 300, shown in FIG. 3, begins at operation 305 in which an OLE request is received. That is, notification is received that an OLE is being requested. The OLE may be either an on-line deletion of a node or an on-line addition of a node.

At operation 310, the nodes of the subject partition, as well as the nodes of any affected partitions, are determined by the management application (i.e., the management application detects nodes impacted by the OLE requested). For one embodiment, the management application is implemented in firmware. For one embodiment, affected partitions include those having nodes for which a removed node acted as a route through a component (in the case of an on-line node removal), and partitions, having nodes that may be used to communicate messages, routed along newly established routing paths (in the case of an on-line node addition). In general, affected partitions include the subject partition and are defined as those partitions for which the occurrence of an OLE results in an alteration of the routing path for any source-destination pair within the partition. It may be that less than all of the partitions of the MPS are affected by the OLE.

At operation 315, all of the source nodes of the subject partition and affected partitions are quiesced. A partition is quiesced when each node of the partition ceases issuing transactions; a transaction being defined as a message that is observable on the external link connecting two nodes. A quiesced partition resumes issuing transactions when subsequently directed to so by the management application. The source nodes include nodes having agents that generate transactions, such as, for example, a processor or an I/O agent. For one embodiment, the quiescing of the source nodes is effected by execution of a specific transaction communicated by the management application. For an alternative embodiment the quiescing of the source nodes is effected by a central agent setting a flag at each of the source nodes. For one embodiment of the invention, each source node is quiesced in a parallel manner. For example, each node receives and examines the quiescing transaction from the management application, and ceases communication of transactions. Each node then awaits completion of all previously communicated request transactions at which time the node agent indicates that quiescing is complete.

At operation 320, which is performed concurrently with the quiescing of the source nodes, the management application begins loading the ART for each determined node, which also includes the routing tables at each link of an intermediate router. In an alternative embodiment, the intermediate router is not associated with a particular node. To avoid deadlock, the node agents do not begin using the ART until quiescing of all source nodes of the subject and affected partitions is complete.

At operation 325, upon completion of the quiescing, the management application communicates a specific transaction to each of the determined node agents directing the node agents to begin using the ART. For one embodiment, the management application sets an indicator in each quiesced node agent resulting in the quiesced nodes resuming their normal operation using the ART. At this point, the OLE request can be granted.

At operation 330, the management application communicates a message to each source node directing the source node to leave quiescence and resume normal operation with the ART now labeled as the PRT.

At operation 335, the original PRT is redesignated to be the ART in anticipation of a subsequent OLE and the management application is informed that the MPS is ready to receive a subsequent OLE request.

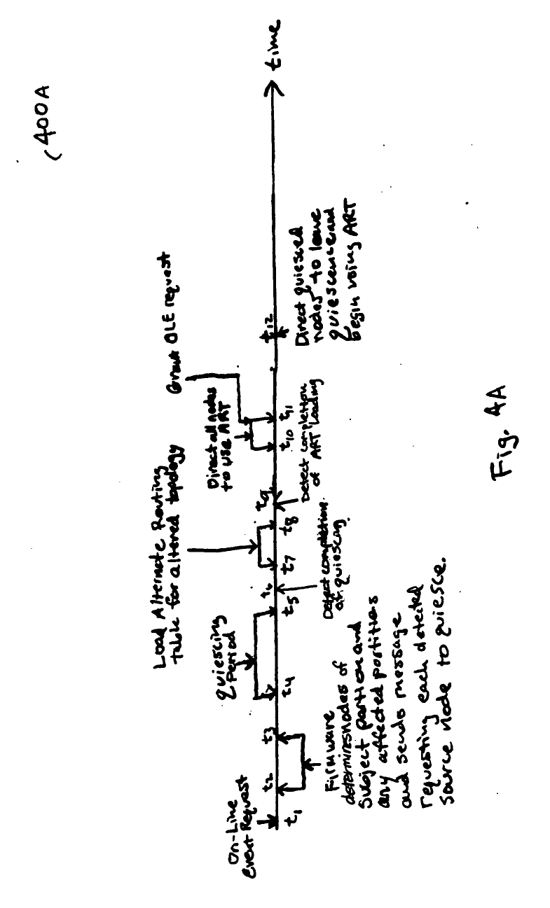

FIG. 4 illustrates a timeline of the operations of process 300, described in reference to FIG. 3, in accordance with one embodiment of the invention. Throughout this Detailed Description, time durations are not necessarily to scale and are meant only to illustrate a progression of distinct events over time. As shown in timeline 400 of FIG. 4, an OLE request is received at time t₁, between time t₁ and time t₂, the firmware determines the nodes of the subject partition and any affected partitions and during the interval from time t₂ to time t₃, sends a message requesting each determined source node to quiesce. The source nodes are quiesced between time t₄ and time t₅. All route throughs are completed and reach destination using the original PRT. For one embodiment, completion of the quiescing period is signaled by a transaction sent by each source node in response to a quiescing message from the management application. Between time t₄ and time t₆, the ARTs are loaded for the altered topology due to the requested OLE. As shown in FIG. 4, loading of the ARTs is initiated and effected generally, concurrently with the quiescing period, thus reducing repartitioning time, and may take more (as shown) or less time than the quiescing of the source nodes. At a subsequent time t₇, the management application detects completion of the quiescing and the ART loading. The management application then directs all nodes to use the ART between time t₈ and time t₉. At time t₉, when all nodes have been directed to use the ART, the OLE request is granted. At time t₁₀, the quiesced nodes are directed to leave quiescence and begin normal operation using the ART.

As shown in FIG. 4, because the transactions communicated using the original PRT are ceased and completed prior to using the ART, transactions using the PRT and transactions using the ART do not overlap in time.

In accordance with the embodiment, as described above in reference to FIG. 3 and FIG. 4, each agent stores both the PRT and the ART, thus requiring routing table storage for both tables. These tables are used for each node and for each link. Storing both the PRT and the ART requires extra area on the integrated circuit component. An alternative embodiment of the invention reduces storage requirements by eliminating the need to store both the PRT and the ART by waiting for quiescence to be completed and then overwriting the PRT with the ART. That is, the ART is stored in the same space on the die as the PRT was stored, thus reducing the routing table storage requirements. This reduction of the routing table storage is acquired at the expense of performance and complexity. That is, the dynamic partitioning will take longer as the loading of the ART can no longer take place concurrently with the source node quiescing, but commences only after completion of the quiescing. Moreover, the complexity of the routing algorithm is increased, as discussed in more detail below.

FIG. 4A illustrates a timeline of a process for effecting dynamic partitioning of an MPS in accordance with one embodiment of the invention. For the embodiment illustrated by FIG. 4A, the quiescing is completed prior to loading the ARTs. Timeline 400A proceeds much the same as timeline 400 of FIG. 4: an OLE request is received at time t₁, between time t₁ and time t₂, the firmware determines the nodes of the subject partition and any affected partitions, and during the interval from time t₂ to time t₃, sends a message requesting each determined source node to quiesce, the source nodes are then quiesced between time t₄ and time t₅. At this point, timeline 400A differs from timeline 400, in that the loading of the ARTs is not initiated and effected concurrently with the quiescing of the source nodes. As shown in timeline 400A, loading the ARTs is initiated only after the application detects completion of the quiescing at time t₆. Between time t₇ and time t₈, the ARTs are loaded for the altered topology due to the requested OLE. At time t₉, the management application detects completion of the ART loading. The management application then directs all nodes to use the ART between time t₁₀ and time t₁₁. At time t₁₁, when all nodes have been directed to use the ART, the OLE request is granted. At time t₁₂, the quiesced nodes are directed to leave quiescence and begin normal operation using the ART.

As noted above, the complexity of the routing algorithm is increased due to the manner in which the PRT is overwritten with the ART at each node. For example, because the PRTs of the nodes in the subject partition and any affected partitions are removed as the update progresses, and the ARTs are as yet inactive, it may not be possible to establish a route to a source agent unless updating is effected in a specific order. In accordance with one embodiment, the management application establishes a linear order among all of the node agents in the subject partition and any affected partitions. The PRT of each node are then overwritten (updated) with the ART in the order established, beginning with the farthest and ending with the closest. In this way, the system does not attempt to communicate completion messages sent by a quiesced node along routes where the PRT cannot be used (i.e., can no longer be used).

Multiple Virtual Network Embodiments

A virtual network (VN) is a set of virtual channels along which any transaction, from a node, can be communicated. One or more VNs may be necessary for deadlock-free routing depending on the system topology. That is, for systems that support multiple VNs, routing algorithms are possible that permit more complex system topologies. For example, ring-based topologies, which reduce average routing distance, and hence, average routing time, require at least two VNs.

For embodiments of the invention described above, the same VN is used for both the PRT and the ART, and it is assumed that one virtual network is sufficient to provide deadlock-free routing for routing algorithms induced by both the PRT and the ART.

Alternative embodiments of the invention may be implemented on systems that support multiple VNs of which at least one VN is not required to support the system topology. For such embodiments, it is possible to effect dynamic partitioning/repartitioning, without quiescing the affected partitions, by restricting routing to less than all of the VNs and then upon notification of an OLE request, switching the routing to an unused VN.

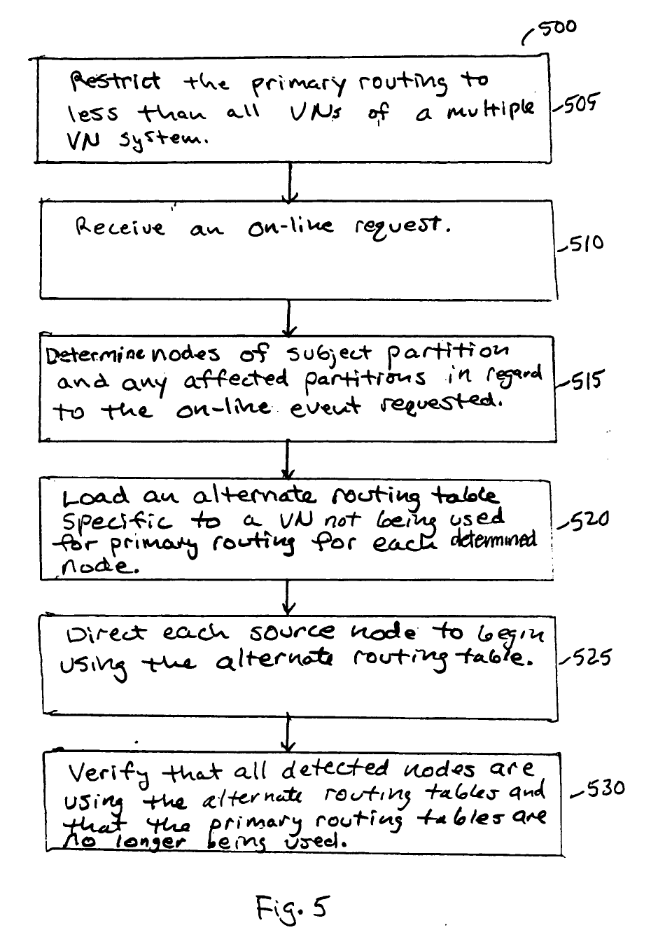

FIG. 5 illustrates a process in which an MPS is dynamically partitioned in accordance with one embodiment of the invention. Process 500, shown in FIG. 5, begins at operation 505 in which the PRT routing is restricted to less than all of the VNs of a multiple-VN system. For example, for a system that supports two VNs, VN₀ and VN₁, the PRT routing is restricted to VN₀.

At operation 510, an OLE request is received. The OLE request is received in response to an OLE, which may be an on-line deletion of a node or an on-line addition of a node.

At operation 515, the nodes of the subject partition, as well as the nodes of any affected partitions, are determined by the management application.

At operation 520, an ART, specific to a VN not being employed for PRT routing (e.g., VN₁), is loaded for each determined node, which also includes the routing tables at each link of an intermediate router. At this point, all of the traffic in the one or more VNs employed for PRT routing continues as usual.

At operation 525, the management application communicates a specific transaction to each of the source node agents directing the node agents to begin using the ART. For one embodiment, the management application sets a control and status register addressed in the configuration space of each respective node agent. At this point, the OLE request can be granted.

At operation 530, upon directing all source node agents to begin using the ART, the management application verifies that all determined nodes are using the ARTs and that the PRTs are no longer in use. The subject partition can then be quiesced with respect to the VN providing PRT routing (e.g., VN₀). For one embodiment, the verification that all determined nodes are using the ARTs and that the PRTs are no longer in use can be effected by the management application issuing a specific transaction (e.g., a “Synch” transaction) to each of the source nodes. In an alternative embodiment, the verification may be effected by a central agent resetting a flag at each of the source nodes. Receipt of an acknowledgment to this transaction from each determined node verifies that all determined nodes are using the ARTs and that the PRTs are no longer in use. For an alternative embodiment, verification can be effected by the management application waiting for a time period equal to at least the longest transaction lifetime for the MPS. The time period is used to determine when a subsequent OLE request can be granted, and is therefore quite flexible.

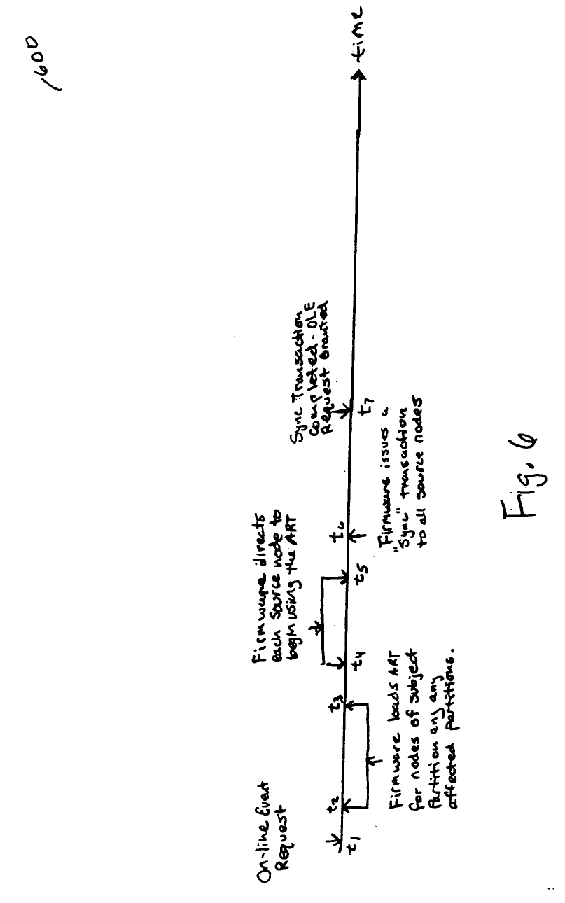

FIG. 6 illustrates a timeline of the operations of process 500, described in reference to FIG. 5, in accordance with one embodiment of the invention. As shown in timeline 600 of FIG. 6, an OLE request is received at time t₁. As described above, the primary routing, prior to receiving the OLE request, is restricted to less than all of the VNs of a multiple VN system. Between time t₁ and time t₂, the management application determines the nodes of the subject partition and any affected partitions and during the interval from time t₂ to time t₃, the management application loads the ART for the altered topology due to the requested OLE. The ART is specific to a VN not being used for primary routing. At time t₄, the management application begins directing the source nodes to use the ART and cease using the PRT. Directing the source nodes to use the ART and stop using the PRT extends over the interval, between time t₄ and time t₅, at which point all source nodes start using the ART. At a subsequent time t₆, the management application detects completion of the quiescing and the ART loading. The management application issues a Sync transaction to all source nodes. Upon completion of the Sync transaction, or alternatively, after the maximum transaction lifetime for the system, at time t₇, the OLE request is granted. At this point, all nodes use the ART for all requests and the PRT is no longer used.

As shown in FIG. 6, there is a time period (from time t₄ to time t₇) during which it is possible that two routing paths exist between a source and destination, a PRT routing path and an ART routing path. Such a situation may lead to interconnect deadlocks. For one embodiment of the invention, the routing is constrained such that the original topology uses a specific deadlock-free VN (or set of deadlock-free VNs), and the altered topology, resulting from the OLE, uses a different deadlock-free VN (or set of deadlock-free VNs). Additionally or alternatively, the routing may be further constrained such that intermediate switching between a PRT routing path and an ART routing path is not permitted. That is, the routing is constrained so that a transaction message remains on the VN on which it originally started its route.

General Matters

Embodiments of the invention provide methods and systems for dynamic partitioning of MPSs. Alternative embodiments of the invention are applicable MPSs having any number of agents and implementing two or more partitions.

Embodiments of the invention include methods having various operations, many of which are described in their most basic form, but operations can be added to or deleted from any of the methods without departing from the basic scope of the invention. The operations of various embodiments of the invention may be performed by hardware components or may be embodied in machine-executable instructions as described above. Alternatively, the operations may be performed by a combination of hardware and software. Embodiments of the invention may be provided as a computer program product that may include a machine-accessible medium having stored thereon instructions, which may be used to program a computer (or other electronic devices) to perform a process according to embodiments of the invention as described above.

A machine-accessible medium includes any mechanism that provides (i.e., stores and/or transmits) information in a form accessible by a machine (e.g., a computer, network device, personal digital assistant, manufacturing tool, any device with a set of one or more processors, etc.). For example, a machine-accessible medium includes recordable/non-recordable media (e.g., read only memory (ROM); random access memory (RAM); magnetic disk storage media; optical storage media; flash memory devices; etc.), as well as electrical, optical, acoustical or other form of propagated signals (e.g., carrier waves, infrared signals, digital signals, etc.); etc.

While the invention has been described in terms of several embodiments, those skilled in the art will recognize that the invention is not limited to the embodiments described, but can be practiced with modification and alteration within the spirit and scope of the appended claims. The description is thus to be regarded as illustrative instead of limiting.

1. A method comprising:
receiving a request for an on-line event, the on-line event in regard to a node of a multiple-node system in which messages are routed using a primary routing table; and
dynamically implementing an alternate routing table for each node of the multiple-node system that is affected by the on-line event, the alternate routing tables reflecting an altered system topology corresponding to the on-line event.

2. The method of claim 1 wherein implementing an alternate routing table for each node of the multiple-node system affected by the on-line event includes quiescing all source nodes of the affected nodes, loading the alternate routing table for each affected node, directing each affected node to use the alternate routing table, and directing each quiesced node to leave quiescence.

3. The method of claim 2 wherein the operation of quiescing all source nodes of affected nodes and the operation of loading the alternate routing table for each affected node are initiated concurrently.

4. The method of claim 2 wherein each source node includes an agent selected from the group consisting of a processor, a memory controller, an input/output hub, a chipset, and integrated combinations thereof.

5. The method of claim 2 further comprising:
redesignating the primary routing table as the alternate routing table in anticipation of a subsequent on-line event; and
providing an indication that the multiple-node system is ready to receive a subsequent on-line event request.

6. The method of claim 4 wherein each node agent stores the primary routing table and the alternate routing table.

7. The method of claim 2 wherein the operation of loading the alternate routing table for each affected node is initiated upon detecting completion of the operation of quiescing all source nodes of affected nodes.

8. The method of claim 7 further comprising:
overwriting the primary routing table for each node with the alternate routing table upon completion of the operation of quiescing all source nodes of affected nodes.

9. The method of claim 8 wherein the overwriting is effected for each node in a specific order such that routing to each source node is possible.

10. The method of claim 1 wherein the multiple-node system supports a plurality of virtual networks, at least one virtual network not required to support a topology of the multiple-node system, and primary routing is not effected on at least one virtual network.

11. The method of claim 10 wherein implementing an alternate routing table for each node of the multiple-node system affected by the on-line event includes determining nodes of a subject partition and any affected partitions, loading the alternate routing table for each determined node, the alternate routing table specific to the at least one virtual network, and directing each determined node to use the alternate routing table.

12. The method of claim 11 further comprising:
quiescing the subject partition;
verifying that all determined nodes are using the alternate routing table and that the primary routing table is not being used by any node; and
granting the on-line event request.

13. The method of claim 12 wherein verifying that the primary routing table is not being used by any node is effected by waiting a time period equal to at least the longest transaction lifetime for the multiple-node system.

14. An article of manufacture comprising:
a machine-accessible medium having associated data, wherein the data, when accessed, results in a machine performing operations comprising:
receiving a request for an on-line event, the on-line event in regard to a node of a subject partition of a multiple-partition, multiple-node system in which messages are routed using a primary routing table;
quiescing all source nodes of the subject partition and any affected partitions in regard to an on-line event request;
loading an alternate routing table for each node of the subject partition and the affected partitions; and
directing each node for which an alternate routing table has been loaded to use the alternate routing table.

15. The article of manufacture of claim 14 wherein the machine-accessible medium further includes data, which when accessed, results in the machine performing an operation comprising directing each quiesced node to leave quiescence.

16. The article of manufacture of claim 14 wherein the machine-accessible medium is a read-only memory device.

17. The article of manufacture of claim 14 wherein the operation of quiescing all source nodes of affected nodes and the operation of loading the alternate routing table for each affected node are initiated concurrently.

18. The article of manufacture of claim 15 further comprising:
redesignating the primary routing table as the alternate routing table in anticipation of a subsequent on-line event; and
providing an indication that the multiple-node system is ready to receive a subsequent on-line event request.

19. The article of manufacture of claim 18 wherein each node agent stores the primary routing table and the alternate routing table.

20. The article of manufacture of claim 15 wherein the operation of loading the alternate routing table for each affected node is initiated upon detecting completion of the operation of quiescing all source nodes of affected nodes.

21. The article of manufacture of claim 20 wherein the machine-accessible medium further includes data, which when accessed, results in the machine performing an operation comprising overwriting the primary routing table for each node with the alternate routing table upon completion of the operation of quiescing all source nodes of affected nodes.

22. An article of manufacture comprising:
a machine-accessible medium having associated data, wherein the data, when accessed, results in a machine performing operations comprising:
receiving a request for an on-line event, the on-line event in regard to a node of a subject partition of a multiple-partition, multiple-node system in which messages are routed using a primary routing table, the multiple node system supporting a plurality of virtual networks, at least one virtual network not required to support a topology of the multiple-node system, and primary routing is not effected on at least one virtual network;
determining nodes of the subject partition and any affected partitions;
loading the alternate routing table for each determined node, the alternate routing table specific to the at least one virtual network; and
directing each determined node to use the alternate routing table.

23. The article of manufacture of claim 22 wherein the machine-accessible medium further includes data, which when accessed, results in the machine performing operations comprising:
quiescing the subject partition;
verifying that all determined nodes are using the alternate routing table and that the primary routing table is not being used by any node; and
granting the on-line event request.

24. The method of claim 23 wherein verifying that the primary routing table is not being used by any node is effected by waiting a time period equal to at least the longest transaction lifetime for the multiple-node system.

25. A system comprising:
a plurality of agents partitioned into a plurality of partitions having one or more agents, the agents having a shared interconnection in which messages are routed using a primary routing table; and
a corresponding memory coupled to each agent, the memory storing instructions which, when executed by a processor, cause the processor to receive a request for an on-line event, the on-line event in regard to one of the agent nodes of a multiple-node system, and dynamically implement an alternate routing table for each agent that is affected by the on-line event, the alternate routing tables reflecting an altered system topology corresponding to the on-line event.

26. The system of claim 25 wherein implementing an alternate routing table for each node of the multiple-node system affected by the on-line event includes quiescing all source nodes of the affected nodes, loading the alternate routing table for each affected node, directing each affected node to use the alternate routing table, and directing each quiesced node to leave quiescence.

27. The system of claim 26 wherein the operation of quiescing all source nodes of affected nodes and the operation of loading the alternate routing table for each affected node are initiated concurrently.

28. The system of claim 26 wherein the operation of loading the alternate routing table for each affected node is initiated upon detecting completion of the operation of quiescing all source nodes of affected nodes, further comprising:
overwriting the primary routing table for each node with the alternate routing table upon completion of the operation of quiescing all source nodes of affected nodes, the overwriting effected for each node in a specific order such that routing to each source node is possible.

29. The system of claim 25 wherein the multiple-node system supports a plurality of virtual networks, at least one virtual network not required to support a topology of the multiple-node system, and primary routing is not effected on at least one virtual network.

30. The system of claim 29 wherein implementing an alternate routing table for each node of the multiple-node system affected by the on-line event includes determining nodes of a subject partition and any affected partitions, loading the alternate routing table for each determined node, the alternate routing table specific to the at least one virtual network, and directing each determined node to use the alternate routing table.
